(19) United States
(12) Patent Application Publication
(10) Pub. No.: US 2025/0353368 A1
(43) Pub. Date: Nov. 20, 2025

(54) VEHICLE LOWER STRUCTURE

(71) Applicant: TOYOTA JIDOSHA KABUSHIKI KAISHA, Toyota-shi (JP)

(72) Inventors: Shigeyuki INOUE, Toyota-shi (JP); Naoya Kawamoto, Nisshin-shi (JP); Takahito Sakuraba, Seto-shi (JP); Kenichi Kakishita, Nagoya-shi (JP); Kohei Takase, Susono-shi (JP); Kai Miyamura, Toyota-shi (JP); Kazuya Kumazawa, Nagoya-shi (JP)

(73) Assignee: TOYOTA JIDOSHA KABUSHIKI KAISHA, Toyota-shi (JP)

(21) Appl. No.: 19/098,313

(22) Filed: Apr. 2, 2025

(30) Foreign Application Priority Data
May 15, 2024 (JP) 2024-079620

(51) Int. Cl. B60K 1/04

(52) U.S. Cl. CPC B60K 1/04; B60K 2001/0438

(57) ABSTRACT

In a vehicle lower structure, an electric power storage device is located below a vehicle frame. The electric power storage device includes an electric power storage module, a peripheral wall portion, a pair of reinforcement portions, and an upper wall portion. The peripheral wall portion extends in the shape of a ring to surround the electric power storage module as viewed from the height direction. The respective reinforcement portions are provided on both sides of the peripheral wall portion in the vehicle right-left direction and integrated with the peripheral wall portion. The upper wall portion is located above the peripheral wall portion and the reinforcement portions to cover the electric power storage module from above. The seal member is configured to seal the region between the vehicle frame and the upper wall portion. The seal member extends in the shape of a ring as viewed from the height direction.

### CROSS-REFERENCE TO RELATED APPLICATION

This application claims priority to Japanese Patent Application No. 2024-079620 filed on May 15, 2024, incorporated herein by reference in its entirety.

### BACKGROUND

### 1. Technical Field

The present disclosure relates to a vehicle lower structure.

### 2. Description of Related Art

Japanese Unexamined Patent Application Publication No. 2020-142589 (JP 2020-142589 A) discloses that a battery pack is provided below a floor panel.

### SUMMARY

Electric power storage devices for vehicles are expected to have ever larger energy capacities. For example, in a vehicle, it is expected that a part of the electric power storage device can function as a floor panel of the vehicle. Such a vehicle has a problem with water entering the region between the vehicle frame and the electric power storage device. It is therefore conceivable to dispose a seal member between the vehicle frame and the electric power storage device. There is, however, room for further improvement to increase the sealability between the vehicle frame and the electric power storage device.

The present disclosure has been devised in view of the problem. An object of the present disclosure is to provide a vehicle lower structure that makes it possible to further increase sealability between a vehicle frame and an electric power storage device.

A vehicle lower structure according to an aspect of the present disclosure includes: a vehicle frame; an electric power storage device; and a seal member. The electric power storage device is located below the vehicle frame. The electric power storage device includes an electric power storage module, a peripheral wall portion, a pair of reinforcement portions, and an upper wall portion. The peripheral wall portion extends in the shape of a ring to surround the electric power storage module as viewed from the height direction. The respective reinforcement portions are provided on both sides of the peripheral wall portion in the vehicle right-left direction. The reinforcement portions are formed to be integrated with the peripheral wall portion. The upper wall portion is located above the peripheral wall portion and the reinforcement portions to cover the electric power storage module from above. The seal member is configured to seal the region between the vehicle frame and the upper wall portion. The seal member extends in the shape of a ring and the whole of a portion of the seal member located outward of the peripheral wall portion is configured to overlap with the reinforcement portions as viewed from the height direction.

In the vehicle lower structure according to an aspect of the present disclosure, the electric power storage module may include a plurality of electric power storage cells. The seal member may be configured to overlap with the electric power storage cells as viewed from the height direction.

The vehicle lower structure according to an aspect of the present disclosure may further include an intermediate member. The electric power storage cells may each include a cell case. The cell case may include a pressure relief valve configured to face a direction along the horizontal direction and release the pressure of the inside of the cell case. The intermediate member may be higher in burning resistance than a resin member included in the electric power storage module. The intermediate member may be disposed above the pressure relief valve.

In the vehicle lower structure according to an aspect of the present disclosure, the pressure relief valve may be configured to face at least one of sides in the vehicle front-rear direction in at least one of the electric power storage cells and be located radially outward of the seal member having the shape of the ring as viewed from the height direction. The intermediate member may be located radially outward of the seal member having the shape of the ring as viewed from the height direction.

The vehicle lower structure according to an aspect of the present disclosure may further include a second intermediate member. The pressure relief valve may be configured to face at least one of the sides in the vehicle front-rear direction in at least another electric power storage cell of the electric power storage cells and be located radially inward of the seal member having the shape of the ring as viewed from the height direction. The second intermediate member may be higher in burning resistance than the resin member included in the electric power storage module. The second intermediate member may be disposed above the pressure relief valve. The second intermediate member may be located radially inward of the seal member having the shape of the ring as viewed from the height direction.

According to the present disclosure, it is possible to further increase sealability between a vehicle frame and an electric power storage device.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a side view of a vehicle including a vehicle lower structure according to an embodiment of the present disclosure;

FIG. 2 is an exploded perspective view of the electric power storage device according to the embodiment of the present disclosure;

FIG. 3 is a plan view of the electric power storage device;

FIG. 4 is a schematic plan view of the electric power storage device with a portion of components removed;

FIG. 5A is a sectional view of a vehicle lower structure in which the electric power storage device in FIG. 3 is illustrated from a direction of arrows of a line VA-VA;

FIG. 5B is a sectional view of a vehicle lower structure in which the electric power storage device in FIG. 3 is illustrated from a direction of arrows of a line VB-VB; and

FIG. 6 is a sectional view of a vehicle lower structure according to a modification example of the embodiment of the present disclosure.

### DETAILED DESCRIPTION OF EMBODIMENTS

A vehicle lower structure according to each of embodiments of the present disclosure will be described below with reference to the drawings. The same or corresponding portions in the drawings will be denoted by the same reference numerals and will not be repeatedly described.

In addition, arrows F, B, U, D, L, R in the drawings used for the following description indicate directions based on a vehicle. The arrow F represents a “front direction”, the arrow B represents a “rear direction”, the arrow U represents an “up direction”, the arrow D represents a “down direction”, the arrow L represents a “left direction”, and the arrow R represents a “right direction”.

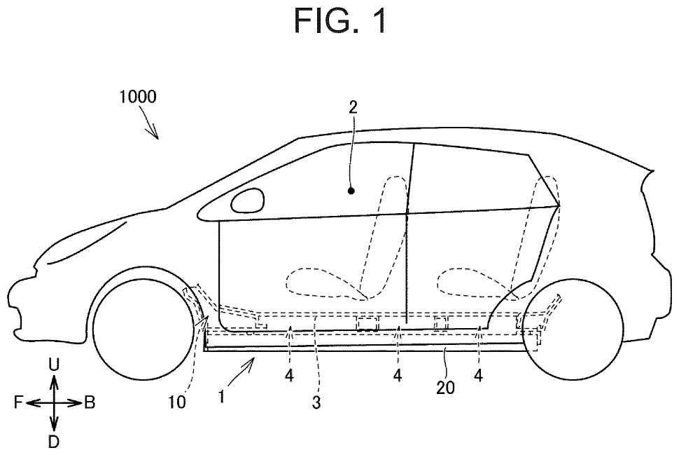

FIG. 1 is a side view of a vehicle including a vehicle lower structure according to an embodiment of the present disclosure. A vehicle 1000 including a vehicle lower structure 1 according to the present embodiment is, for example, an electrified vehicle such as a battery electric vehicle or a hybrid electric vehicle that is drivable by a motor. The vehicle 1000 includes a vehicle cabin 2. The vehicle cabin 2 is located above the vehicle lower structure 1.

The vehicle 1000 may further include a floor carpet 3 and a cushioning member 4. The floor carpet 3 defines the vehicle cabin 2. The cushioning member 4 is disposed below the floor carpet 3. The cushioning member 4 may include a member that weighs less than metal and is softer than metal. The cushioning member 4 includes a member including, for example, foamed resin.

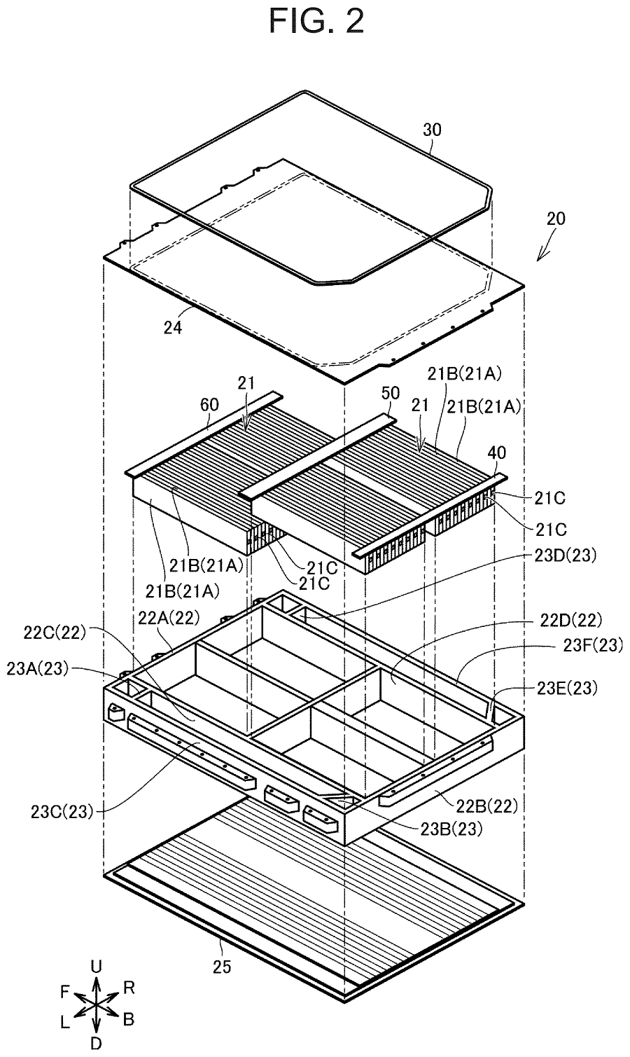

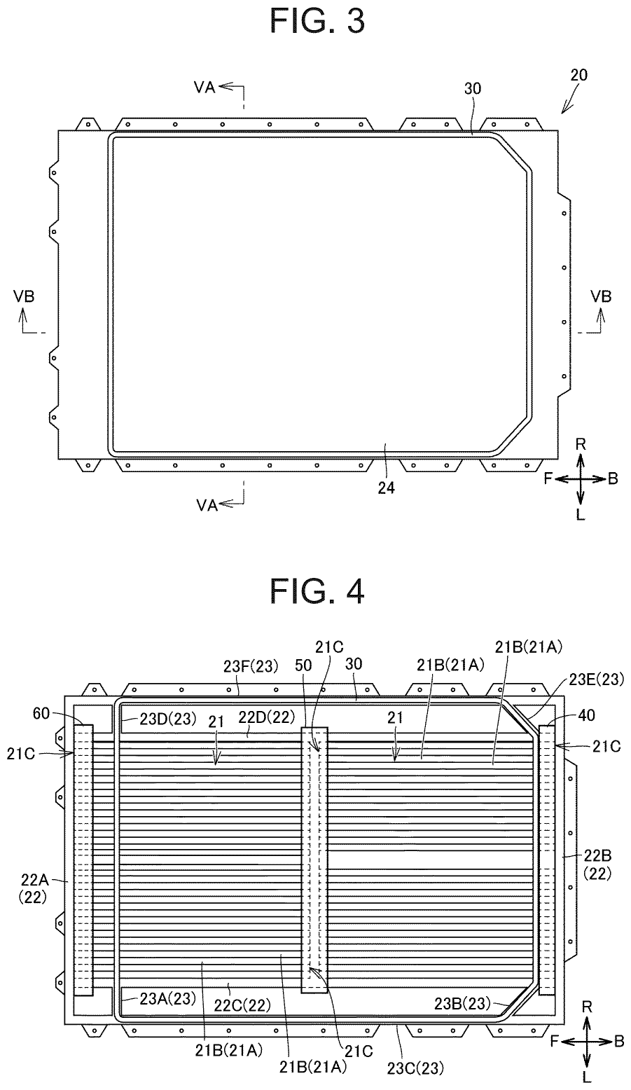

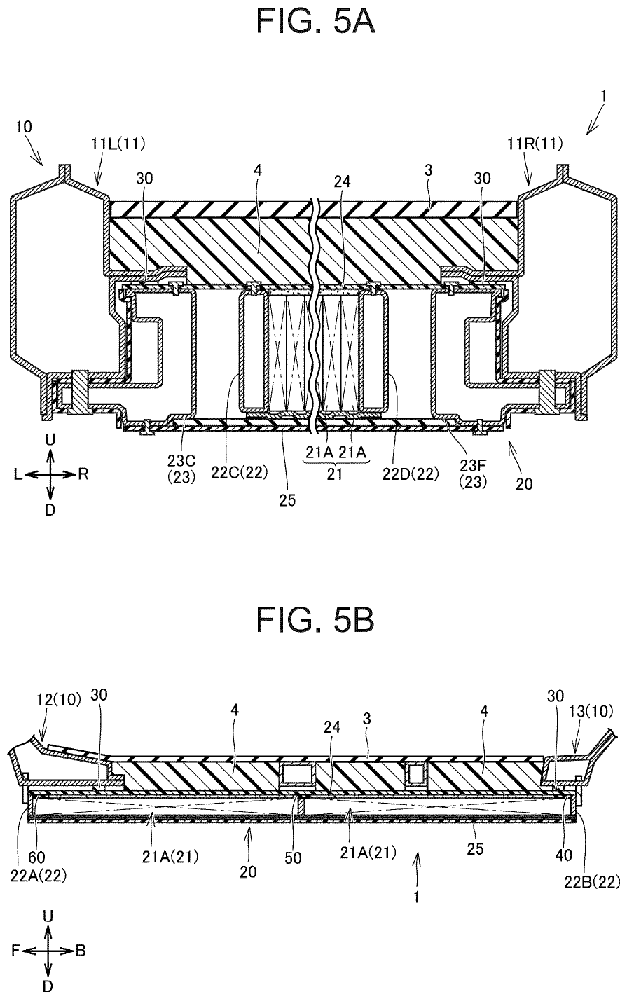

FIG. 2 is an exploded perspective view of the electric power storage device according to the embodiment of the present disclosure. FIG. 3 is a plan view of the electric power storage device. FIG. 4 is a schematic plan view of the electric power storage device with a portion of components removed. FIG. 5A is a sectional view of the vehicle lower structure in which the electric power storage device in FIG. 3 is illustrated from the direction of the arrows of a line VA-VA. FIG. 5B is a sectional view of the vehicle lower structure in which the electric power storage device in FIG. 3 is illustrated from the direction of the arrows of a line VB-VB.

As illustrated in FIG. 2 to FIG. 5B, the vehicle lower structure 1 according to the embodiment of the present disclosure includes a vehicle frame 10, an electric power storage device 20, a seal member 30, an intermediate member 40, a second intermediate member 50, and a third intermediate member 60.

The vehicle frame 10 includes a pair of side members 11, a front member 12, and a rear member 13. The vehicle frame 10 does not have to include a floor panel that defines the vehicle cabin 2.

The side members 11 extend in the vehicle front-rear direction (see FIG. 5A). The respective side members 11 are located on both sides of the center of the vehicle lower structure 1 in the vehicle width direction. The side members 11 include a left side member 11L and a right side member 11R. The left side member 11L is located closer to the left side of the vehicle lower structure 1 than the center in the vehicle width direction. The right side member 11R is located closer to the right side of the vehicle lower structure 1 than the center in the vehicle width direction.

The front member 12 extends in the vehicle width direction (see FIG. 5B). The front member 12 connects the front portions of the side members 11 to each other.

The rear member 13 extends in the vehicle width direction (see FIG. 5B). The rear member 13 connects the rear portions of the side members 11 to each other.

As illustrated in FIG. 1, FIG. 2, FIG. 5A, and FIG. 5B, the electric power storage device 20 is located below the vehicle frame 10.

The electric power storage device 20 includes an electric power storage module 21, a peripheral wall portion 22, a pair of reinforcement portions 23, an upper wall portion 24, and a lower wall portion 25. FIG. 4 illustrates the electric power storage device with the upper wall portion 24 removed for the convenience of description.

The electric power storage module 21 includes a plurality of electric power storage cells 21A. The electric power storage cells 21A are arranged in the right-left direction. The electric power storage cells 21A are arranged in the front-rear direction.

The electric power storage cells 21A each include a cell case 21B. The cell case 21B accommodates an electrode body (not illustrated). The cell case 21B includes a pressure relief valve 21C that faces a direction along the horizontal direction and releases the pressure of the inside of the cell case 21B (see FIG. 2 and FIG. 4).

In at least one of the electric power storage cells 21A, the pressure relief valve 21C faces at least one of the sides in the vehicle front-rear direction. Of the electric power storage cells 21A arranged in the right-left direction, the electric power storage cells 21A each including the pressure relief valve 21C facing the front side and the electric power storage cells 21A each including the pressure relief valve 21C facing the rear side are alternately disposed in the right-left direction. The electric power storage module 21 includes the two electric power storage cells 21A. The two electric power storage cells 21A are arranged in the front-rear direction.

As illustrated in FIG. 2, FIG. 4, FIG. 5A, and FIG. 5B, the peripheral wall portion 22 extends in the shape of a rectangular ring to surround the electric power storage module 21 as viewed from the height direction. The peripheral wall portion 22 includes a front wall portion 22A, a rear wall portion 22B, a left wall portion 22C, and a right wall portion 22D. The front wall portion 22A may be fixed to the front member 12 (see FIG. 5B). The rear wall portion 22B may be fixed to the rear member 13.

The respective reinforcement portions 23 are provided on both sides of the peripheral wall portion 22 in the vehicle right-left direction. The reinforcement portions 23 are formed to be integrated with the peripheral wall portion 22.

The reinforcement portions 23 include a left front reinforcement portion 23A, a left rear reinforcement portion 23B, a left side reinforcement portion 23C, a right front reinforcement portion 23D, a right rear reinforcement portion 23E, and a right side reinforcement portion 23F.

The left front reinforcement portion 23A and the left rear reinforcement portion 23B extend from the left side of the peripheral wall portion 22. The left side reinforcement portion 23C is connected to the left front reinforcement portion 23A and the left rear reinforcement portion 23B. The left side reinforcement portion 23C is separated from the peripheral wall portion 22. The left side reinforcement portion 23C may be fixed to the left side member 11L (see FIG. 5A).

The right front reinforcement portion 23D and the right rear reinforcement portion 23E extend from the right side of the peripheral wall portion 22. The right side reinforcement portion 23F is connected to the right front reinforcement portion 23D and the right rear reinforcement portion 23E. The right side reinforcement portion 23F is separated from the peripheral wall portion 22. The right side reinforcement portion 23F may be fixed to the right side member 11R (see FIG. 5A).

The upper wall portion 24 is located above the peripheral wall portion 22 and the reinforcement portions 23 to cover the electric power storage module 21 from above. The upper wall portion 24 may be in direct contact with the peripheral wall portion 22 and the reinforcement portions 23. The upper wall portion 24 may be, for example, carbon fiber reinforced plastics (CFRPs).

The seal member 30 seals the region between the vehicle frame 10 and the upper wall portion 24. It is sufficient if the seal member 30 is an elastically deformable member. The seal member 30 may be formed by using, for example, a rubbery resin member or foamed resin.

In the present embodiment, the whole of the seal member 30 may extend along the horizontal direction. It is thus possible to restrain the seal member 30 from varying in seal surface pressure. The seal member 30 extends in the shape of a ring and the whole of a portion of the seal member 30 located outward of the peripheral wall portion 22 overlaps with the reinforcement portions 23 as viewed from the height direction.

Furthermore, the seal member 30 overlaps with the electric power storage cells 21A as viewed from the height direction. In addition, in at least one of the electric power storage cells 21A, the pressure relief valve 21C is located radially outward of the seal member 30 having the shape of a ring as viewed from the height direction. In at least another electric power storage cell 21A of the electric power storage cells 21A, the pressure relief valve 21C is located radially inward of the seal member 30 having the shape of a ring as viewed from the height direction.

More specifically, a portion of the pressure relief valves 21C is located forward of the seal member 30. Another portion of the pressure relief valves 21C is located rearward of the seal member 30. Still another portion of the pressure relief valves 21C is located radially inward of the seal member 30.

The intermediate member 40 (first intermediate member), the second intermediate member 50, and the third intermediate member 60 each include material including a resin member higher in burning resistance than the resin member included in the electric power storage module 21. An example of the resin member included in the electric power storage module 21 includes a separator or an insulating member (any of which is not illustrated) included in the electric power storage module 21.

It is possible to use an Underwriter's Laboratories (UL) standard (the standard of UL test No. 94) and the like as examples to evaluate burning resistance. It is possible to use, for example, a glass cloth, a carbon cloth including carbon fiber, a fluorine fiber cloth including fluorine fiber, a fluororesin film, or the like as a member that increases burning resistance. For example, resin material such as polybutylene terephthalate (PBT) may be used as a base material, and a halogen compound, antimony oxide, glass fiber, or the like may be added.

The intermediate member 40, the second intermediate member 50, and the third intermediate member 60 are disposed above the pressure relief valve 21C. The intermediate member 40 is located radially outward of the seal member 30 having the shape of the ring as viewed from the height direction. The intermediate member 40 is located rearward of the seal member 30, but may be located forward of the seal member 30. The second intermediate member 50 is located radially inward of the seal member 30 having the shape of the ring as viewed from the height direction. The third intermediate member 60 is located radially outward of the seal member 30 having the shape of the ring as viewed from the height direction. The third intermediate member 60 is located forward of the seal member 30, but may be located rearward of the seal member 30.

As described above, the vehicle lower structure 1 according to the embodiment of the present disclosure includes the vehicle frame 10, the electric power storage device 20, and the seal member 30. The electric power storage device 20 is located below the vehicle frame 10. The electric power storage device 20 includes the electric power storage module 21, the peripheral wall portion 22, the pair of reinforcement portions 23, and the upper wall portion 24. The peripheral wall portion 22 extends in the shape of a ring to surround the electric power storage module 21 as viewed from the height direction. The respective reinforcement portions 23 are provided on both sides of the peripheral wall portion 22 in the vehicle right-left direction. The reinforcement portions 23 are formed to be integrated with the peripheral wall portion 22. The upper wall portion 24 is located above the peripheral wall portion 22 and the reinforcement portions 23 to cover the electric power storage module 21 from above. The seal member 30 seals the region between the vehicle frame 10 and the upper wall portion 24. The seal member 30 extends in the shape of a ring and the whole of a portion of the seal member 30 located outward of the peripheral wall portion 22 overlaps with the reinforcement portions 23 as viewed from the height direction.

The reinforcement portions 23 extending from the peripheral wall portion 22 each have high rigidity and are relatively difficult to deflect. Therefore, according to the configuration, the seal member 30 and the upper wall portion 24 are firmly sandwiched between the vehicle frame 10 and the upper wall portion 24 at the portion of the seal member overlapping with the reinforcement portions 23. The scalability of the region between the vehicle frame 10 and the electric power storage device 20 by the seal member 30 thus further increases.

According to the embodiment of the present disclosure, the electric power storage module 21 includes the electric power storage cells 21A. The seal member 30 overlaps with the electric power storage cells 21A as viewed from the height direction.

According to the configuration, it is possible to increase the scalability of the seal member 30 on both sides of the electric power storage module 21 in the vehicle right-left direction and increase the proportion of the electric power storage cells 21A in the electric power storage module 21 in the vehicle front-rear direction of the electric power storage module 21. It is consequently possible to increase the energy capacity of the electric power storage device 20 included in the vehicle lower structure 1. In addition, the upper wall portion 24 located above the electric power storage cells 21A is restrained from being curved. Thus, the scalability of the seal member 30 also increases above the electric power storage cells 21A.

The vehicle lower structure 1 according to the embodiment of the present disclosure further includes the intermediate member 40. The electric power storage cells 21A each include the cell case 21B. The cell case 21B includes the pressure relief valve 21C that faces a direction along the horizontal direction and releases the pressure of the inside of the cell case 21B. The intermediate member 40 is higher in burning resistance than a resin member included in the electric power storage module 21. The intermediate member 40 is disposed above the pressure relief valve 21C.

According to the configuration, the intermediate member 40 makes it possible to restrain, even in a case where the pressure relief valve 21C opens at the time of an abnormality and the pressure relief valve 21C catches fire, the fire from being transferred upward.

In the embodiment of the present disclosure, the pressure relief valve 21C faces at least one of the sides in the vehicle front-rear direction in at least one of the electric power storage cells 21A and is located radially outward of the seal member 30 having the shape of the ring as viewed from the height direction. The intermediate member 40 is located radially outward of the seal member 30 having the shape of the ring as viewed from the height direction.

According to the configuration, even in a case where the pressure relief valve 21C catches fire at the time of an abnormality, it is possible to restrain the fire from being transferred to the inner side of the seal member 30 having the shape of a ring and it is possible to further restrain the fire from being transferred toward the vehicle cabin. Furthermore, the intermediate member 40 makes it possible to restrain the fire from being transferred upward even on the outer side of the seal member 30 having the shape of a ring.

The vehicle lower structure 1 according to the embodiment of the present disclosure further includes the second intermediate member 50. The pressure relief valve 21C faces at least one of the sides in the vehicle front-rear direction in at least another electric power storage cell 21A of the electric power storage cells 21A and is located radially inward of the seal member 30 having the shape of the ring as viewed from the height direction. The second intermediate member 50 is higher in burning resistance than a resin member included in the electric power storage module 21. The second intermediate member 50 is disposed above the pressure relief valve 21C. The second intermediate member 50 is located radially inward of the seal member 30 having the shape of the ring as viewed from the height direction.

According to the configuration, even in a case where pressure relief valve 21C catches fire at the time of an abnormality, the second intermediate member 50 makes it possible to restrain the fire from being transferred upward on the inner side of the seal member 30 having the shape of a ring.

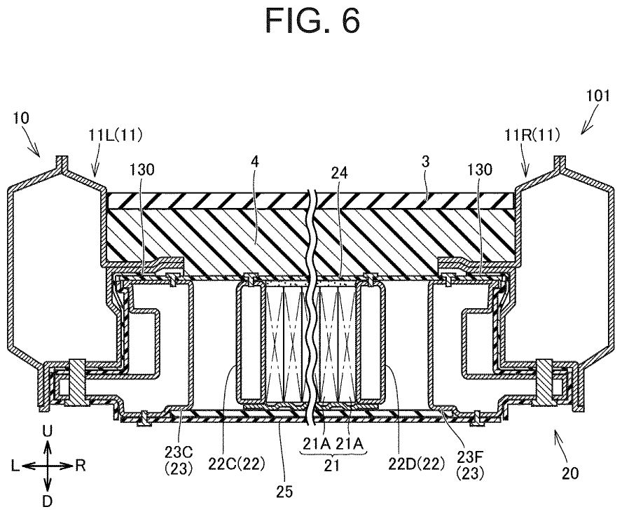

It is to be noted that the whole of the seal member 30 does not have to extend along the horizontal direction. FIG. 6 is a sectional view of a vehicle lower structure according to a modification example of the embodiment of the present disclosure. FIG. 6 illustrates a section in a sectional view corresponding to the sectional view illustrated in FIG. 5A.

In a vehicle lower structure 101 according to the present modification example, a seal member 130 extends from a region on the upper wall portion 24 to the position at which the left side member 11L and the left side reinforcement portion 23C are fixed. The seal member 130 extends from a region on the upper wall portion 24 to the position at which the right side member 11R and the right side reinforcement portion 23F are fixed.

The embodiment disclosed herein should be understood as an example in all respects, but should not be understood as being restrictive. The scope of the present disclosure is demonstrated by the claims instead of the description. The scope of the present disclosure is intended to include the equivalents to the claims and all modifications within the scope of the claims.

What is claimed is:

1. A vehicle lower structure comprising:
a vehicle frame;
an electric power storage device; and
a seal member, wherein:
the electric power storage device is located below the vehicle frame;
the electric power storage device includes
an electric power storage module,
a peripheral wall portion,
a pair of reinforcement portions, and
an upper wall portion;
the peripheral wall portion extends in a shape of a ring to surround the electric power storage module as viewed from a height direction;
the respective reinforcement portions are provided on both sides of the peripheral wall portion in a vehicle right-left direction and integrated with the peripheral wall portion;
the upper wall portion is located above the peripheral wall portion and the reinforcement portions to cover the electric power storage module from above; and
the seal member is configured to seal a region between the vehicle frame and the upper wall portion, and the seal member extends in a shape of a ring and a whole of a portion of the seal member located outward of the peripheral wall portion is configured to overlap with the reinforcement portions as viewed from the height direction.

2. The vehicle lower structure according to claim 1, wherein:
the electric power storage module includes a plurality of electric power storage cells; and
the seal member is configured to overlap with the electric power storage cells as viewed from the height direction.

3. The vehicle lower structure according to claim 2, further comprising an intermediate member, wherein:
the electric power storage cells each include a cell case;
the cell case includes a pressure relief valve configured to face a direction along a horizontal direction and release pressure of inside of the cell case; and
the intermediate member is higher in burning resistance than a resin member included in the electric power storage module and is disposed above the pressure relief valve.

4. The vehicle lower structure according to claim 3, wherein:
the pressure relief valve is configured to face at least one of sides in a vehicle front-rear direction in at least one of the electric power storage cells and is located radially outward of the seal member having the shape of the ring as viewed from the height direction; and
the intermediate member is located radially outward of the seal member having the shape of the ring as viewed from the height direction.

5. The vehicle lower structure according to claim 4, further comprising a second intermediate member, wherein:
the pressure relief valve is configured to face at least one of the sides in the vehicle front-rear direction in at least another electric power storage cell of the electric power storage cells and is located radially inward of the seal member having the shape of the ring as viewed from the height direction; and
the second intermediate member is higher in burning resistance than the resin member included in the electric power storage module, is disposed above the pressure relief valve, and is located radially inward of the seal member having the shape of the ring as viewed from the height direction.
